(19) United States
(12) Patent Application Publication
(10) Pub. No.: US 2002/0193112 A1
(43) Pub. Date: Dec. 19, 2002

(54) Mobile communication apparatus

(75) Inventors: Ippo Aoki, Tokyo (JP); Akira Ishikura, Kanagawa-ken (JP)

Correspondence Address: BANNER & WITCOFF, 1001 G STREET N W, SUITE 1100, WASHINGTON, DC, 20001, US

(73) Assignee: Kabushiki Kaisha Toshiba, Tokyo (JP)

(21) Appl. No.: 10/125,571

(22) Filed: Apr. 19, 2002

(30) Foreign Application Priority Data
Apr. 19, 2001 (JP) P2001-121254

(51) Int. Cl. H04Q 7/20

(52) U.S. Cl. 455/437; 455/550; 455/575

(57) ABSTRACT

A mobile communication apparatus is offered which can arbitrarily change a base station to be connected preferentially either by the base station or by a user. Then, the apparatus can be connected with the base station. This mobile communication apparatus has a memory in which priority information is stored. An identification number is stored for each different location area. A base station to which priority is given is captured from the identification number. A control portion carries out this operation. A request signal for causing a certain request to be executed by the mobile communication apparatus is included in the control signal transmitted from the base station. This request signal requests the apparatus to search a specific base station. It is also possible that a user voluntarily selects a specific base station. The apparatus is connected with this base station.

### RELATED APPLICATION INFORMATION

This application claims priority under 35 U.S.C. §119 to Japanese patent application P2001-121254 filed on Apr. 19, 2001, whose contents are expressly incorporated herein by reference.

### FIELD OF THE INVENTION

This invention relates to a mobile communication apparatus storing system identification number (SID), priority information, location area code, and frequency information.

### DESCRIPTION OF THE RELATED ART

Generally, cellular phone systems provided by the communication common carriers in the United States use predetermined frequency bandwidth. The cellular phone systems use A-block frequency and B-block frequency in 800 MHz bandwidth.

A-block, B-block, C-block, D-block, E-block, and F-block in 1.9 GHz bandwidth have been added for the cellular phone service. Thus the cellular phone systems in the United States now use these frequency blocks in 800 MHz bandwidth and 1.9 GHz bandwidth.

The common carrier does not always use the same bandwidth in the United States because the carriers in the United States merge frequently. For example, a communication common carrier may use A-block frequency in 800 MHz in the west region of the United States and B-block frequency in 1.9 GHz in the east region.

Generally, a cellular phone provided by the communication common carrier has a function to search a base station in the cellular phone system efficiently based on the System Identification code (SID) provided by the communication common carrier to which the cellular phone belongs.

The cellular phone can search a base station related to the best reasonable carrier to communicate with using this function. System Selection for Preferred Roaming (SSPR) is one example of this function. A cellular phone having the function of SSPR has a Preferred Roaming List (PRL) in the memory.

The PRL includes SID, priority information for SID, location area code, and frequency information. The cellular phone can search a base station related to the best reasonable carrier to communicate based on the PRL. The SSPR is standardized in IS-683A standard in the United States.

When a cellular phone having the SSPR function found the base station that has SID stored in PRL, the cellular phone specifies the location area where the apparatus is currently located.

Then, the cellular phone tries to search another base station based on the stored priority information for SID. After searching, the mobile communication then shifts to its idling state.

It is necessary to change the stored PRL based on the priority information in case that the service of the cellular phone is provided by the carrier supporting both 800 MHz frequency bandwidth and 1.9 GHz frequency bandwidth.

There are several drawbacks the carrier to prepare cellular phones having PRL for 800 MHz frequency bandwidth and cellular phones having PRL for 1.9 GHz frequency bandwidth. One of the drawbacks is that the carrier has to prepare the space for stocking both types of cellular phones.

The carrier can provide the cellular phone to users; the cellular phone stores a plurality of PRLs for all frequency bandwidths in the memory. But it is difficult to store all PRLs for all frequency bandwidths in the memory because each PRL is very large size.

Furthermore, a cellular phone often cannot establish a radio channel link with a base station because other cellular phones already use other radio channels in the frequency bandwidth. The cellular phone often cannot establish a radio cannel link with another base station because the base station uses another frequency bandwidth.

In this situation, the cellular phone has to wait until it can establish a radio channel link with a base station. It wastes much time for a user to wait until it can establish a radio channel link with a base station. Otherwise, a user of the cellular phone has to use another cellular phone.

Generally, a cellular phone has priority information in PRL regarding a frequency bandwidth to search a base station. For example, one part of the priority information indicates that the cellular phone tries to search a base station in the 800 MHz at first, and next tries to search a base station in the 1.9 GHz. In this situation, the cellular phone takes a long time to search the base station in the 1.9 GHz.

### SUMMARY

In view of the foregoing problems with the prior art technique, it is an aspect of this invention to provide a mobile communication apparatus storing priority information for capable of connecting to a base station, the mobile communication apparatus comprising: a receiver configured to receive a request to change the stored priority information; and a selector configured to select the base station based on the changed priority information.

It is another aspect of this invention to provide a mobile communication apparatus for connecting to a base station, the mobile communication apparatus comprising: a memory configured to store identifying information identifying a base station, priority information for connecting to the base station, and a location area of the base station; a receiver configured to receive a request to connect to a base station and identifying information identifying the base station; a changing unit configured to change the stored priority information based on the received request; a first detector configured to detect identifying information for connecting a base station; a second detector configured to detect a location area based on the detected identifying information; and a searching unit configured to search a base station in the detected location area based on the changed priority, wherein the searched base station has higher priority information than that of the connecting base station.

### BRIEF DESCRIPTION OF THE DRAWINGS

FIG. 1 is a functional block diagram illustrating electrical connections of a mobile communication apparatus in accordance with one embodiment of this invention;

FIG. 2 is a table stored in the memory shown in FIG. 1, showing an acquisition table that is a list in which frequency band, communication type, and channel number are correlated with acquisition indexes;

FIG. 3 is a system table stored in the memory shown in FIG. 1, showing a system table that is a list in which base station system identification number (SID), priority information, and acquisition index are correlated with location area information;

FIG. 4 is a flowchart illustrating a sequence of operations for causing the mobile communication apparatus shown in FIG. 1 to search a base station optimal for this apparatus and to enter into a idling state with the base station or to display an “No service” message because there is no connectable base station;

FIG. 5 is a flowchart illustrating operations of the mobile communication apparatus shown in FIG. 1 until the apparatus enters into a idling state with a base station corresponding to a certain acquisition index by referring to a system table in order to search the base station preferentially; and

FIG. 6 is a flowchart illustrating operations of the mobile communication apparatus shown in FIG. 1 until the apparatus makes a second system table for preferentially searching a base station corresponding to an acquisition index in response to an instruction from the base station for searching the base station and enters into a idling state with the base station by referring to the second system table.

### DETAILED DESCRIPTION OF THE EMBODIMENTS

Hereafter, illustrative embodiments of the present invention will be described with reference to the drawings.

A mobile communication apparatus in this embodiment has priority information about frequency bandwidth in Preferred Roaming List (PRL) stored in a memory. The PRL include SID that is stored in according to a location area. The apparatus can search a frequency bandwidth based on the priority information.

Accordingly, the apparatus can put a priority on the frequency bandwidths without rewriting the PRL.

As a result, a carrier that uses these different frequency bandwidths in a location area can increase the transmission capacity efficiency. Hence, it is possible to decrease the chance that a user cannot establish a radio channel link.

The carrier can use the radio channel link efficiently and can enhance the cost effectiveness.

Furthermore, it is useful for users of mobile communication apparatus to decrease the chance that a user cannot establish a radio channel link.

This invention is applicable to different kinds of the frequency bandwidths as well as to different communication types (e.g., analog or digital communication system).

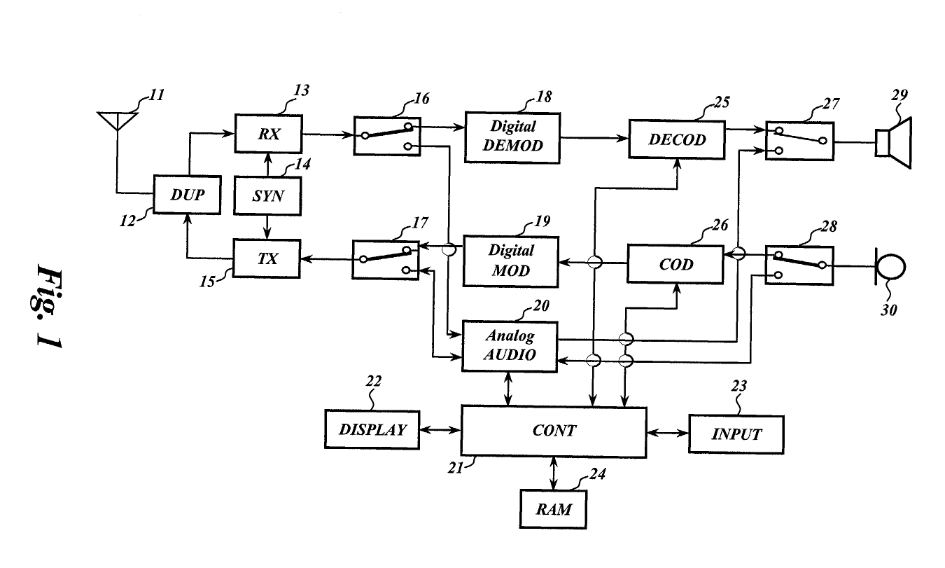

A specific example of a mobile communication apparatus in accordance with one embodiment of this invention is described by referring to FIGS. 1-5.

FIG. 1 shows a mobile communication apparatus in accordance with this embodiment.

The mobile communication apparatus shown in FIG. 1 can be used in the analog communication system and digital communication system. In particular, the apparatus can be used in the both systems by switching switches 16, 17, 27, and 28.

The user can operate an input portion (INPUT) 23 to switch these switches. After operating the INPUT 23, a signal indicating the contents of the operation is sent to a control (CONT) portion 21, whereby the switching operation can be carried out.

The apparatus can receive a radio signal from the base station and detect a type of the received signal. One of the types is analog radio signal used in the analog communication system. One of the types is digital radio signal used in the digital communication system.

A control portion (CONT) 21 in the apparatus controls switches 16, 17, 27, and 28.

First, we describe a case that the apparatus is used in a digital communication system.

In this case, the switches 16, 17, 27, and 28 shown in FIG. 1 are connected with their upper terminal. The switches 16, 17, 27, and 28 shown in FIG. 1 merely show functional connections on a circuit.

It is not always necessary that the apparatus should have two terminals and that a physical switch should be switched between the terminals. Any type of the switch can be used in the apparatus.

In FIG. 1, an antenna 11 receives a radio frequency signal from a base station. The received signal is inputted to the receiving circuit (RX) 13 through an antenna duplexer (DUP) 12.

This RX 13 has a low-noise amplifier and a frequency converter. The low-noise amplifier amplifies the received signal with low noise. Then, the frequency converter mixes the low-noise amplified signal with a local oscillation signal generated by a frequency synthesizer (SYN) 14 and converts them into a receiver intermediate-frequency signal or a receiver base band signal. The converted signal is inputted to a digital demodulator (DEMOD) 18 through a switch 16.

The digital demodulator 18 demodulates into a digital signal. The digital demodulator 18 can use a quadrature demodulation method corresponding to Quadrature Phase-Shift Keying (QPSK).

The control portion 21 assigns the local oscillation signal frequency generated by the frequency synthesizer 14.

The demodulated signal is inputted to a decoder (DECOD) circuit 25. This demodulated signal is a kind of an encoded voice signal from a calling party. The decoder circuit 25 decodes the encoded signal.

The decoder circuit 25 also modulates the decoded signal into a Pulse Code Modulation (PCM) signal.

The modulated signal is inputted to a D/A converter (digital-to-analog converter). The D/A converter converts into an analog voice signal. An amplifier amplifies the analog voice signal having a desired magnitude. The amplified voice signal is inputted to a loudspeaker 29 through the upper terminal in the switch 27.

An amplifier amplifies a voice signal inputted from a microphone 30 by a user. The amplified signal is inputted to an A/D converter (analog-to-digital converter) through the upper terminal in the switch 28. The A/D converter converts the inputted signal into a PCM signal.

An encoder (COD) circuit 26 encodes the converted PCM signal into a voice signal. Then, the control portion 19 inputs the encoded voice signal to a digital modulator (digital MOD) 19.

The digital modulator 19 modulates the encoded voice signal and inputs to a transmitting (TX) circuit 15 through the upper terminal in the switch 17.

The transmit circuit 15 is includes a frequency converter and a transmit power amplifier. The frequency converter mixes the modulated voice signal with a local oscillation signal generated by the frequency synthesizer (SYN) 14. The digital modulator 19 modulates the mixed voice signal into an analog signal. The digital modulator 19 can use a quadrature modulation method corresponding to Quadrature Phase-Shift Keying (QPSK).

The modulated analog signal is amplified to a desired transmit level by the transmit power amplifier and then inputted to the antenna 11 via the antenna duplexer 12. The signal is transmitted to a base station from the antenna 11.

Next, we describe a case that the apparatus is used in an analog communication system.

In this case, the switches 16, 17, 27, and 28 shown in FIG. 1 are connected with their lower terminal.

In FIG. 1, an antenna 11 receives a radio frequency signal from a base station. The received signal is inputted to the receiving circuit (RX) 13 through an antenna duplexer (DUP) 12.

This RX 13 has a low-noise amplifier and a frequency converter. The low-noise amplifier amplifies the received signal with low noise. Then, the frequency converter mixes the low-noise amplified signal with a local oscillation signal generated by a frequency synthesizer (SYN) 14 and converts them into a receiver intermediate-frequency signal or a receiver base band signal. The converted signal is inputted to an analog audio-processing (analog AUDIO) circuit 20 through a switch 16.

The control portion 21 assigns the local oscillation signal frequency generated by the frequency synthesizer 14. The demodulated signal in an analog audio-processing circuit 20 is a kind of a modulated voice signal from a calling party.

An amplifier amplifies the analog voice signal having a desired magnitude. The amplified voice signal is inputted to a loudspeaker 29 through the lower terminal in the switch 27.

An amplifier amplifies a voice signal inputted from a microphone 30 by a user. The amplified signal is inputted to an analog audio-processing circuit 20 through the lower terminal in the switch 28.

The analog audio-processing circuit 20 modulates the voice signal and inputs to a transmitting (TX) circuit 15 through the upper terminal in the switch 17.

The transmit circuit 15 is includes a frequency converter and a transmit power amplifier. The frequency converter mixes the modulated voice signal with a local oscillation signal generated by the frequency synthesizer (SYN) 14.

The modulated analog signal is amplified to a desired transmit level by the transmit power amplifier and then inputted to the antenna 11 via the antenna duplexer 12. The signal is transmitted to a base station from the antenna 11.

A power-supply portion (not shown in FIG. 1) has a battery such as a lithium-ion battery, a charging circuit for charging the battery, and a voltage-generating circuit. The voltage-generating circuit consists of a DC/DC converter, for example, and creates a desired power-supply voltage based on the output voltage from the battery.

The input portion 23 permitting a user to operate this mobile communication apparatus is connected with the control portion 21.

This input portion 23 is used to input an indication to start voice communication or characters for Short Messaging Service (SMS).

Furthermore, a display (DISPLAY) portion 22 for displaying the entered numerals and characters, the residual amount of the battery regarding the power supply, etc. is connected to the control portion 21.

Additionally, a memory (RAM) 24 storing PRL including acquisition tables, system tables, etc. is connected with the control portion 21.

The acquisition table is a kind of list. The list includes a radio frequency bandwidth, communication type (digital or analog), and radio channel number.

The system table is a kind of list. The list includes system identification numbers (SIDs) of base stations, priority information, acquisition indexes, and location area information.

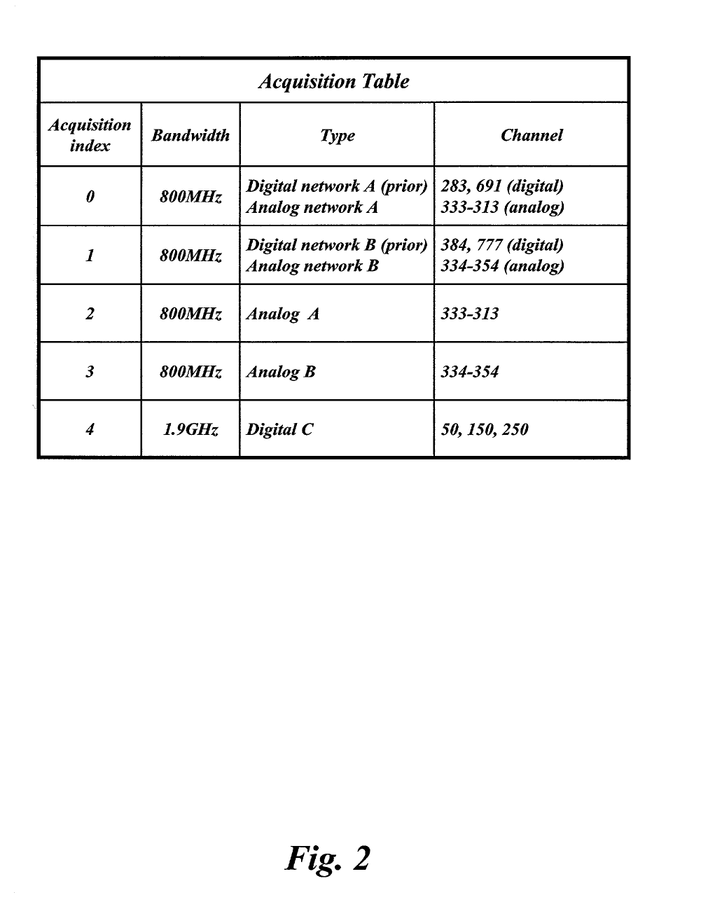

FIG. 2 shows one example of an acquisition table in this embodiment. FIG. 2 shows that the acquisition table has five types (acquisition index 0-4) of base stations in this embodiment.

The acquisition table shows that the frequency bandwidth 800 MHz is used by the base station whose acquisition index is “0”, the base station whose acquisition index is “1”, the base station whose acquisition index is “2”, and the base station whose acquisition index is “3”. The acquisition table also shows that the frequency bandwidth 1.9 GHz is used by the base station whose acquisition index is “4”.

The “type” in the acquisition table shows one or more types of a base station, the types include an analog radio communication system and a digital radio communication system.

For example, the base station whose acquisition index is “0” can be used in a digital radio communication system A and an analog radio communication system A. In this embodiment, the digital radio communication system A has a priority order to connect.

If a mobile communication apparatus can be used in a digital communication system A and analog communication system A, the apparatus selects the base station whose acquisition index is “0” in the digital communication system A.

If a mobile communication apparatus can be used only in a analog communication system A, the apparatus selects the base station whose acquisition index is “0” in the analog communication system A.

For another example, the base station whose acquisition index is “4” can be used only in a digital radio communication system C. If a mobile communication apparatus can be used only in analog radio communication system, the mobile communication apparatus cannot be used in the digital radio communication system C.

The “channel” in the acquisition table shows a number of one or more radio communication channels the base station is able to use in the radio communication system.

Radio communication channels in a digital communication system are set discretely (i.e., acquisition indexes 0, 1, and 4), Radio communication channels in a analog communication system are set consecutively (i.e., acquisition indexes 0, 1, 2 and 3).

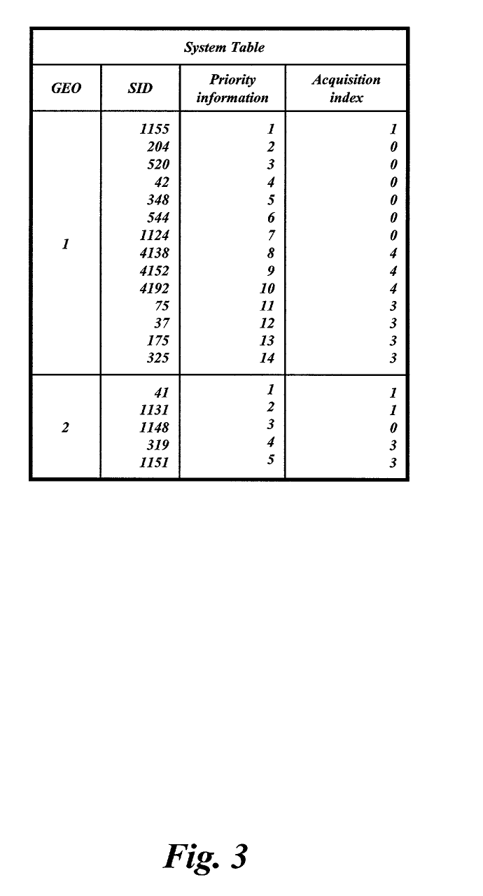

FIG. 3 shows one example of a system table in this embodiment.

The system table as shown in FIG. 3 includes “GEO”, “system identification (SID)”, “priority”, and “acquisition index”.

The system table shown in FIG. 3 has two type (“GEO” is “1” or “2”) of location area in this embodiment.

The system table shows that the location area whose “GEO” is 1 has 14 base stations.

The SIDs of the 14 base stations are 1155, 204, 520, 42, 348, 544, 1124, 4138, 4152, 4192, 75, 37, 175, and 325.

The system table shows that the location area whose “GEO” is 2 has 5 base stations. The SIDs of the 5 base stations are 41, 1131, 1148, 319, and 1151.

The “SID” indicates a number to identify the base station. “SID” is corresponding to an acquisition index. For example, SID “1155” is corresponding to acquisition index “1”. SID “4138” is corresponding to acquisition index “4”.

The “priority” indicates prior order with which a mobile communication apparatus should be connected. For example, when a mobile communication apparatus tries to connect with a base station in the location area whose GE is “2”, the mobile communication apparatus tries to connect sequentially with a base station based on the “priority”, i.e., the least number of priority.

If all attempts to connect with all base stations in the location area are failing, the apparatus displays an alarm message on the display 22. The alarm message indicates that the apparatus cannot connect with any base stations in the location area.

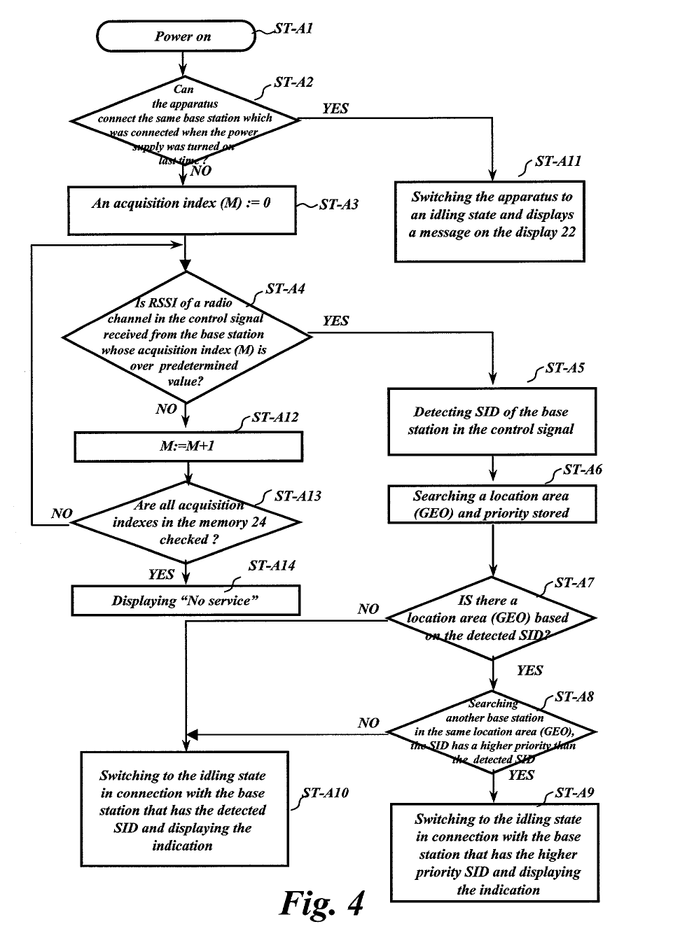

FIG. 4 shows how a mobile communication apparatus searches a best base station and switch to the idling state when it could connect the base station and displays an alarm message on the display 22 when it could not connect the base station. The control portion 21 executes this procedure shown in FIG. 4 with referring a PRL in the memory 24.

At the same time when a power supply in the mobile communication apparatus is turned on (ST-A1), the control portion 21 checks whether the apparatus can connect the base station which was connected when the power supply was turned on last time (ST-A2).

The control portion 21 searches a base station based from which the apparatus can receive a control signal on a condition that the Received Signal Strength Indicator (RSSI) of a radio channel in the control signal is over predetermined value, the radio cannel is used in the connection with the base station on last time. The condition includes that the apparatus detects the same SID of the base station was connected on last time.

When the apparatus can connect with the same base station on last time, the control portion 21 switches the apparatus to an idling state and displays a message on the display 22 (ST-A11). The alarm message shows the idling state in the apparatus.

When the apparatus cannot connect with the same base station on last time, the control portion 21 sets an acquisition index (M) as “0” to search a base station to connect (ST-A3).

Next, the control portion 21 checks whether the apparatus can receive a control signal from the base station whose acquisition index (M) is “0” (ST-A4). The control portion 21 checks it on condition that the Received Signal Strength Indicator (RSSI) of a radio channel in the control signal is over predetermined value.

For example, at first, the control portion 21 sets a frequency generated form the frequency synthesizer 14 to a radio channel “CH283” and tries to receive a control signal in the radio channel from the base station in the digital radio communication system A.

When the control portion 21 does not receive the control signal in the radio channel “CH283” whose RSSI is not over predetermined value, the control portion 21 change the frequency to a radio channel number “CH691” and tries to receive a control signal in the changed radio channel from the base station in the digital radio communication system A.

When the control portion 21 does not receive the control signal in the radio channel “CH691” whose RSSI is not over predetermined value, the control portion 21 tries to receive a control channel from a base station in an analog radio communication system A.

When the control portion 21 does not receive the control signal from the base station, the control portion 21 adds a number of acquisition index “M” by 1 (ST-A12).

Next, the control portion 21 decides whether it checks all acquisition indexes in the memory 24 or not in condition that the Received Signal Strength Indicator (RSSI) of a radio channel in the control signal is over predetermined value (ST-A13).

When the control portion 21 decides it does not check all acquisition indexes in the memory 24 yet, the control portion 21 checks whether the apparatus can receive a control signal from the base station until all acquisition indexes in the memory 24 will be checked (ST-A4).

When the control portion 21 decides it already checks all acquisition indexes in the memory 24, the control portion 21 displays an alarm message (ST-A14). The alarm message indicates that the apparatus cannot connect with all base stations in the location area. For example, the message is indicated as “No service” or “Not in service”.

When the control portion 21 receives a control signal from a base station (ST-A4) in condition that RSSI in the control signal is over predetermined value, the control portion 21 detects the SID of the base station in the control signal (ST-A5).

Based on the detected SID, the control portion 21 detects a location area (GEO) and priority information stored in the system table in the memory 24 (ST-A6).

The control portion 21 checks whether it can search a detected location area (GEO) based on the detected SID (ST-A7).

When the control portion 21 cannot search a detected location area (GEO), the control portion 21 switches to the idling state that the apparatus can connect with the base station that has the detected priority SID and displays the indication (ST-A10).

When the control portion 21 can detect a location area (GEO), the control portion 21 executes the following procedure (ST-A8).

After detecting a location area (GEO) in the system table, the control portion 21 searches another base station that has a SID in the same location area (GEO). The SID has higher priority information than that of the detected SID.

When the control portion 21 can search the another base station which has the higher priority information, the control portion 21 checks whether it can receive a control signal whose RSSI is over predetermined value from the base station.

When the control portion 21 cannot search another base station that has the higher priority information or cannot receive a control signal whose RSSI is over predetermined value from the base station, the control portion 21 switches to an idling state that the apparatus can connect with the base station that has the detected SID and displays the indication (ST-A10).

When the control portion 21 can search another base station that has the higher priority information (ST-A8), the control portion 21 switches to an idling state that the apparatus can connect with the base station that has the higher priority information and displays the indication (ST-A9).

As described thus far, with respect to the mobile communication apparatus in this embodiment, the apparatus searches a location area based on a detected SID in a control signal. The location area is stored in the system table in the memory 24.

When the apparatus can search the higher priority SID in the system table, it tries to receive a control signal from the base station that has the higher priority SID.

When the apparatus can receive the control signal from the base station in condition that RSSI in the control signal is over predetermined value, the apparatus switches to an idling state that can connect with the base station that has the higher priority SID.

Accordingly, the mobile communication apparatus can connect the base station that is preferable for a user of the apparatus.

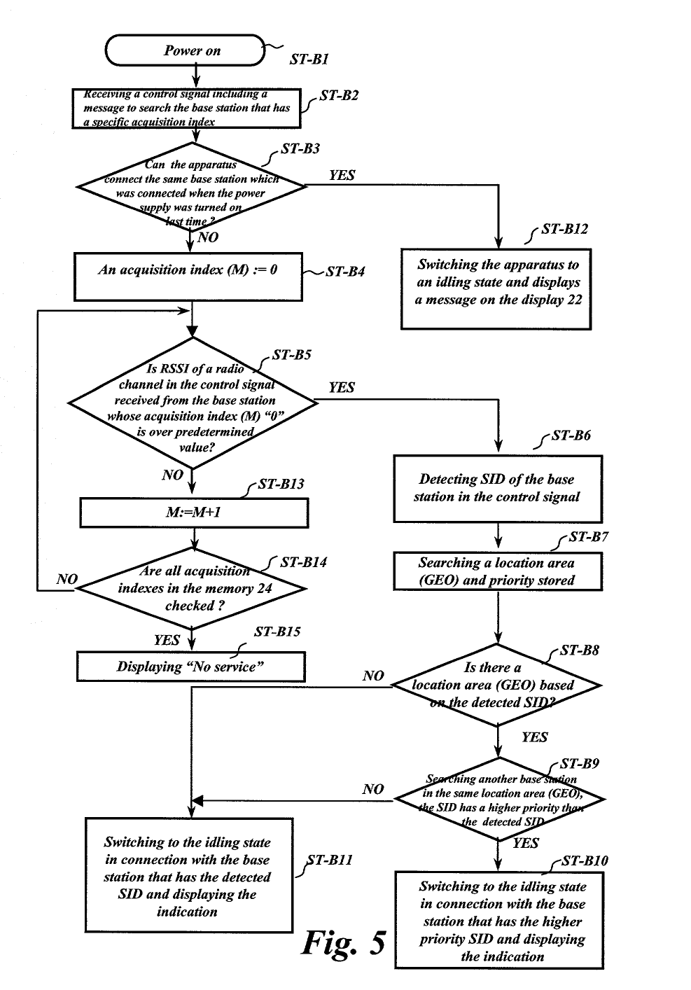

FIG. 5 shows another embodiment. In this embodiment, the control portion 21 sets the base stations, each of which has an acquisition index “4” as highest priority.

The control portion 21 stores items which are related to the acquisition index “4” as a list in the memory. The items comprise a part of the system table in the memory 24.

At first, the control portion 21 checks whether it can detect a base station that has higher priority information in the list. After checking in the list, the control portion 21 checks whether it can detect a base station that has higher priority information or not in the system table.

In this embodiment, the control portion 21 stores items which are related to each of the acquisition indexes as a list in the memory.

The control portion 21 may change the address of the item which has the acquisition index “4” to the top address in the stored system table. In this case, the control portion 21 determines the top address has the highest priority.

In this embodiment, a control signal transmitted from a base station includes a message to assign a mobile communication apparatus to communicate with a base station. For example, if the control signal includes a message to assign to communicate with a base station which has the acquisition index “4”, the apparatus, which has the system table shown in FIG. 2, can communicate with the base station which is used in the 1.9 GHz frequency bandwidth digital radio communication system C.

If the control signal includes a message to assign to communicate with the base station that has the acquisition index “2” or the acquisition index “3”, the apparatus, which has the system table shown in FIG. 2, can communicate with the base station that is used in the 800 MHz frequency bandwidth analog radio communication system A or the 800 MHz frequency bandwidth analog radio communication system B. In this case, it may be preferable that the control signal includes information indicating priority to the acquisition index “2” or information indicating priority to the acquisition index “3”.

After a power is supplied to a mobile communication apparatus (ST-B1), the apparatus receives a control signal from a base station; the control signal includes a message to search the base station that has a specific acquisition index (ST-B2). It is preferable that all base station may transmit the control signal.

The control portion 21 stores the specific acquisition index included in the control signal in the memory 24. If the message includes a plurality of specific acquisition indexes and priority information about the acquisition indexes, the control portion 21 stores them in the memory 24.

Based on the priority information, the control portion 21 can select a list. The control portion 21 can select an originally system table stored in the memory 24.

Next, the control portion 21 checks whether the apparatus can connect the base station which was connected when the power supply was turned on last time (ST-B3).

The control portion 21 searches a base station based from which the apparatus can receive a control signal on a condition that the Received Signal Strength Indicator (RSSI) of a radio channel in the control signal is over predetermined value, the radio cannel is used in the connection with the base station on last time. The condition includes that the apparatus detects the same SID of the base station was connected on last time.

When the apparatus can connect with the same base station on last time, the control portion 21 switches the apparatus to an idling state and displays a message on the display 22 (ST-B12). The alarm message shows the idling state in the apparatus.

When the apparatus cannot connect with the same base station on last time, the control portion 21 sets an acquisition index (M) as “0” to search a base station to connect (ST-B4).

Next, the control portion 21 checks whether the apparatus can receive a control signal from the base station whose acquisition index (M) is “0” (ST-B5). The control portion 21 checks it on condition that the Received Signal Strength Indicator (RSSI) of a radio channel in the control signal is over predetermined value.

When the control portion 21 does not receive the control signal from all of the base station whose acquisition index is “M”, the control portion 21 adds a number of acquisition index “M” by 1 (ST-B13).

Next, the control portion 21 decides whether it checks all acquisition indexes in the memory 24 or not in condition that the Received Signal Strength Indicator (RSSI) of a radio channel in the control signal is over predetermined value (ST-B14).

When the control portion 21 decides it does not check all acquisition indexes in the memory 24 yet, the control portion 21 checks whether the apparatus can receive a control signal from a base station until all acquisition indexes in the memory 24 will be checked.

When the control portion 21 determines it has already checked all acquisition indexes stored in the memory 24, the control portion 21 displays an alarm message (ST-B15). The alarm message indicates that the apparatus cannot connect with all base stations in the location area. For example, the message is indicated as “No service” or “Not in service”.

When the control portion 21 receives a control signal from a base station (ST-B5) in condition that RSSI in the control signal is over predetermined value, the control portion 21 detects the SID of the base station in the control signal (ST-B6).

Based on the detected SID, the control portion 21 detects a location area (GEO) and priority information stored in the system table in the memory 24 (ST-B7).

The control portion 21 checks whether it can search the detected location area (GEO) based on the detected SID (ST-B8).

When the control portion 21 cannot search a location area (GEO), the control portion 21 switches to the idling state that the apparatus can connect with the base station that has the detected SID and displays the indication (ST-B11).

When the control portion 21 can detect a location area (GEO), the control portion 21 executes the following procedure (ST-B9).

After detecting a location area (GEO) in the system table, the control portion 21 searches another base station that has a SID in the same location area (GEO). The SID has higher priority information than that of the detected SID.

The control portion 21 searches another base station in a list in the memory 24 based on the received control signal. The control portion 21 stores items which are related to the acquisition index as the list in the memory.

When the control portion 21 can search the another base station which has the higher priority information in the list, the control portion 21 checks whether it can receive a control signal whose RSSI is over predetermined value from the base station which has the higher priority SID.

When the control portion 21 cannot search another base station that has the higher priority information or cannot receive a control signal whose RSSI is over predetermined value from the base station, the control portion 21 switches to an idling state that the apparatus can connect with the base station that has the detected priority SID and displays the indication (ST-B11).

When the control portion 21 can search another base station that has the higher priority information (ST-B9) in the list, the control portion 21 switches to an idling state that the apparatus can connect with the base station that has the higher priority information and displays the indication (ST-B10).

In another embodiment, the operator of the apparatus may input a specific acquisition index by INPUT 23.

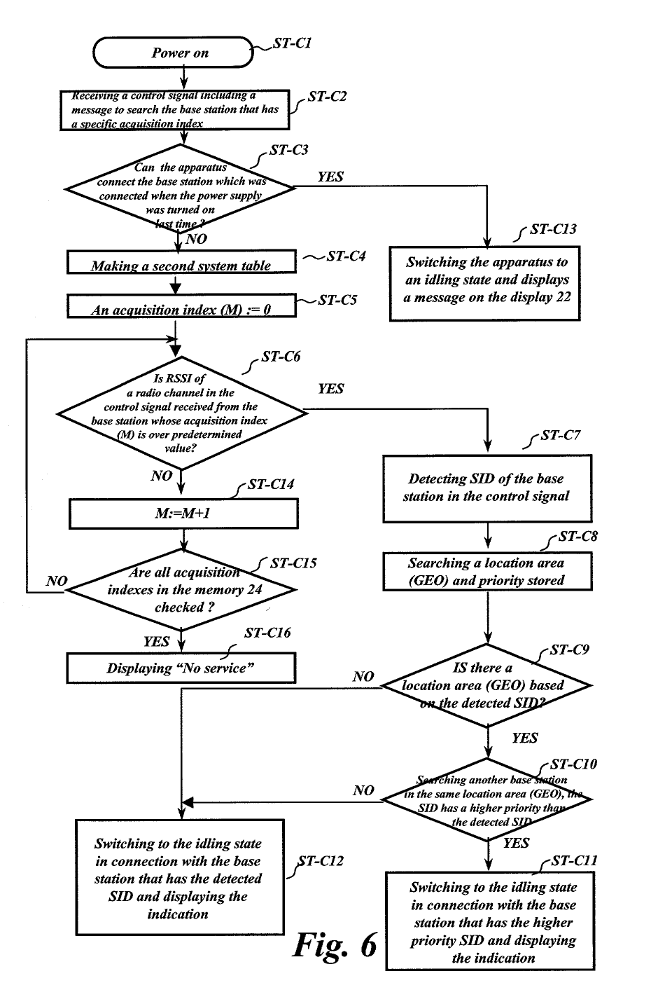

FIG. 6 shows another embodiment. In the embodiment as shown in FIG. 5, the memory 24 has a plurality of lists because the control portion 21 stores items which are related to each of the acquisition indexes as a list in the memory 24.

On the other hand, in the embodiment as shown in FIG. 6, a mobile communication apparatus makes and stores a second system table in the memory 24.

The control portion 21 makes the second system table based on the acquisition index which is assigned as the highest priority by a control signal or operation of the user.

In this embodiment, compared as the embodiment as shown in FIG. 5, the memory 24 can store more information because the control portion 21 makes only one other system table.

After a power is supplied to a mobile communication apparatus (ST-C1), the apparatus receives a control signal from a base station; the control signal includes a message to search the base station that has a specific acquisition index (ST-C2). It is preferable that all base stations transmit the control signal. The control portion 21 stores the specific acquisition index in the memory 24.

If the message includes a plurality of specific acquisition indexes and priority information about the acquisition indexes, the control portion 21 can make a plurality of new system tables.

Next, the control portion 21 checks whether the apparatus can connect the base station which was connected when the power supply was turned on last time (ST-C3).

The control portion 21 searches a base station based from which the apparatus can receive a control signal on a condition that the Received Signal Strength Indicator (RSSI) of a radio channel in the control signal is over predetermined value, the radio cannel is used in the connection with the base station on last time. The condition includes that the apparatus detects the same SID of the base station was connected on last time.

When the apparatus can connect with the same base station on last time, the control portion 21 switches the apparatus to an idling state and displays a message on the display 22 (ST-C13). The alarm message shows the idling state in the apparatus.

When the apparatus cannot connect with the same base station on last time, the control portion 21 detects items which are related to the specific acquisition index assigned by the control signal. The control portion 21 makes a second system table in the memory 24 based on the detected items (ST-C4).

For example, if the control signal assigns the acquisition index “4”, the control portion 21 makes a second system table wherein the highest priority acquisition index is “4”.

The control portion 21 may make the second system table during the time between the step “ST-C2” and the step “ST-10” because the second system table is used in the step “ST-10” at first time.

Next, the control portion 21 sets an acquisition index (M) as “0” to search a base station to connect (ST-C5).

Next, the control portion 21 checks whether the apparatus can receive a control signal from the base station whose acquisition index (M) is “0” (ST-C6). The control portion 21 checks it on condition that the Received Signal Strength Indicator (RSSI) of a radio channel in the control signal is over predetermined value.

When the control portion 21 does not receive the control signal from all of the base station whose acquisition index is “M”, the control portion 21 increases the number of acquisition index “M” by 1 (ST-C14).

Next, the control portion 21 decides whether it checks all acquisition indexes in the memory 24 or not in condition that the Received Signal Strength Indicator (RSSI) of a radio channel in the control signal is over predetermined value (ST-C15).

When the control portion 21 decides it does not check all acquisition indexes in the memory 24 yet, the control portion 21 checks whether the apparatus can receive a control signal from a base station until all acquisition indexes in the memory 24 will be checked.

When the control portion 21 determines it has already checked all acquisition indexes stored in the memory 24, the control portion 21 displays an alarm message (ST-C16). The alarm message indicates that the apparatus cannot connect with all base stations in the location area. For example, the message is indicated as “No service” or “Not in service”.

When the control portion 21 receives a control signal from a base station (ST-C6) in condition that RSSI in the control signal is over predetermined value, the control portion 21 detects the SID of the base station in the control signal (ST-C7).

Based on the detected SID, the control portion 21 detects location area (GEO) and priority information stored in the system table in the memory 24 (ST-C8).

The control portion 21 checks whether it can search the detected location area (GEO) based on the detected SID (ST-C9).

When the control portion 21 cannot search a location area (GEO), the control portion 21 switches to the idling state that the apparatus can connect with the base station that has the detected SID and displays the indication (ST-C12).

When the control portion 21 can detect a location area (GEO), the control portion 21 executes the following procedure (ST-C10).

After detecting a location area (GEO) in the system table, the control portion 21 searches another base station that has a SID in the same location area (GEO). The SID has higher priority information than that of the detected SID.

The control portion 21 searches another base station in a second system table in the memory 24. The control portion 21 made and stored the second system table in step “ST-C4”.

When the control portion 21 can search the another base station which has the higher priority information in the second system table, the control portion 21 checks whether it can receive a control signal whose RSSI is over predetermined value from the base station which has the higher priority SID.

When the control portion 21 cannot search another base station that has the higher priority information or cannot receive a control signal whose RSSI is over predetermined value from the base station, the control portion 21 switches to an idling state that the apparatus can connect with the base station that has the detected priority SID and displays the indication (ST-C12).

When the control portion 21 can search another base station that has the higher priority information (ST-C10) in the second system table, the control portion 21 switches to an idling state that the apparatus can connect with the base station that has the higher priority information and displays the indication (ST-C11).

In another embodiment, the operator of the apparatus may input a specific acquisition index by INPUT 23.

Because of the process steps described thus far, a mobile apparatus in this invention can preferentially search a base station corresponding to a specific acquisition index.

As a result, the mobile communication apparatus can connect with the best reasonable base station in a short time easily.

Consequently, the power consumption of the mobile communication apparatus can be suppressed to a low level.

It is to be noted that this invention is not restricted to the above-described embodiments but rather can be practiced in various modified forms within the technical scope of the invention. With the mobile communication apparatus in accordance with this invention, the user of the apparatus or base stations select a base station that should be connected with the apparatus. The base station to be connected preferentially can be changed at will by the base stations or by the user. This high-priority base station is connected with the mobile communication apparatus. Furthermore, processing time taken to make a link with a base station can be shortened by arbitrarily changing a base station to be connected preferentially. Also, the power consumption can be reduced.

What is claimed is:

1. A mobile communication apparatus storing priority information for capable of connecting to a base station, the mobile communication apparatus comprising:
a receiver configured to receive a request to change the stored priority information; and
a selector configured to select the base station based on the changed priority information.

2. The mobile communication apparatus according to claim 1, wherein the selector comprises:
a changing unit configured to change the priority information based on the received request;
a detector configured to detect identifying information identifying the connecting base station and the location area based on the detected identifying information; and
a searching unit configured to search a base station in the detected location area based on the changed priority information, wherein the searched base station has higher priority information than that of the connecting base station.

3. The mobile communication apparatus according to claim 2, wherein the changing unit stores priority information for connecting to a base station.

4. The mobile communication apparatus according to claim 2, wherein the changing unit stores a plurality of priority information for connecting to a base station.

5. A mobile communication apparatus for connecting to a base station, the mobile communication apparatus comprising:
a memory configured to store identifying information identifying a base station, priority information for connecting to the base station, and a location area of the base station;
a receiver configured to receive a request to connect to a base station and identifying information identifying the base station;
a changing unit configured to change the stored priority information based on the received request;
a first detector configured to detect identifying information for connecting a base station;
a second detector configured to detect a location area based on the detected identifying information; and
a searching unit configured to search a base station in the detected location area based on the changed priority, wherein the searched base station has higher priority information than that of the connecting base station.

6. The mobile communication apparatus according to claim 5, wherein the memory stores a plurality of priority information for connecting to a base station.
